(19) United States
(12) Patent Application Publication
(10) Pub. No.: US 2012/0089943 A1
(43) Pub. Date: Apr. 12, 2012

(54) INITIATING AND COMPLETING TRANSACTIONS VIA NOTIFICATION ELEMENTS

(75) Inventors: Kalpit Jain, Redmond, WA (US); Jeffrey Scott Neafsey, Golden, CO (US)

(73) Assignee: MICROSOFT CORPORATION, Redmond, WA (US)

(21) Appl. No.: 12/899,188

(22) Filed: Oct. 6, 2010

(51) Int. Cl. G06F 3/048; G06F 3/033; G06F 21/00

(52) U.S. Cl. 715/808; 726/4; 715/863

(57) ABSTRACT

Initiating and completing transactions using a notification architecture associated in part with an operating system executing on a first computing device. The transactions are associated with a second computing device (e.g., a merchant computing device). Transaction messages relating to the transactions are conveyed via the notification architecture to the first computing device of a user. User interface notification elements associated with the operating system on the first computing device display the transaction messages, and receive authorization from the user relating to the transactions. The authorization is provided to the merchant computing device by the notification architecture. The transactions are completed without executing, on the first computing device, an application associated with the merchant computing device.

### BACKGROUND

With existing systems, users conduct online transactions via web browsers or other applications executing on a computing device. The online transactions include those at merchant web sites (e.g., buying/selling goods or services), auctions, banking institutions, and other destinations accessible by the computing device. To complete the transactions, the users have to remember the addresses of each of the web sites and the particular logins and passwords for each of the web sites. Additionally, the users typically receive notifications as email messages or as physical mail. With today's users having many email accounts to check, the users can easily miss a time-sensitive notification such as a due date for a bill.

The existing systems fail to reduce the complexity and challenges associated with the notification and completion of online transactions. In examples where the computing device is a mobile device such as a mobile telephone or netbook, additional difficulties due at least to the small form factor of the mobile device are also present.

### SUMMARY

Embodiments of the disclosure enable users to complete transactions via user interface notification elements associated with an operating system. A first computing device receives the transaction message from a second computing device. The transaction message identifies a transaction associated with an application available on the first computing device. The transaction message further specifies a user of the first computing device. The received transaction message is provided to the user via the user interface notification elements associated with the operating system executing on the first computing device. User input to the user interface notification element is received. The user input indicates an authorization relating to the transaction. The authorization is provided to the second computing device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a computing device operating to display transaction messages to a user.

FIG. 2 is an exemplary flow chart illustrating operation of the computing device to provide transaction messages to the user and receive authorization for the transactions.

FIG. 3 is an exemplary block diagram illustrating communication between a mobile computing device, a notification service, and a merchant computing device to enable positive or negative authorization of transactions by the user.

FIG. 4 is an exemplary mobile computing device illustrating display of a transaction message in a banner on a user interface.

FIG. 5 is an exemplary mobile computing device illustrating display of a transaction message in a tile on the user interface.

FIG. 6 is an exemplary block diagram illustrating a sequence of user interface notification elements corresponding to a transaction.

Corresponding reference characters indicate corresponding parts throughout the drawings.

### DETAILED DESCRIPTION

Referring to the figures, embodiments of the disclosure enable the notification and completion of transactions using user interface notification elements provided by an operating system 112 of a computing device 104 of a user 102. Aspects of the disclosure enable merchants to initiate and complete any transaction with the user 102 via notification functionality associated with the operating system 112 executing on the computing device 104 of the user 102 (e.g., without executing a user-level application on the computing device 104).

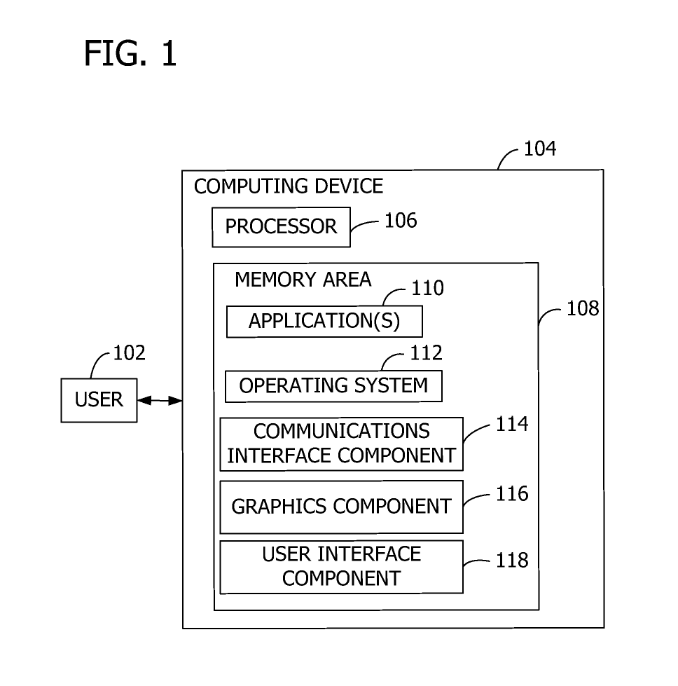

Referring again to FIG. 1, an exemplary block diagram illustrates the computing device 104 operating to display transaction messages to the user 102. In the example of FIG. 1, the computing device 104 is associated with the user 102. The computing device 104 represents any device executing instructions (e.g., as application programs, operating system functionality, or both) to implement the operations and functionality associated with the computing device 104. The computing device 104 may include a mobile computing device 302 or any other portable device. In some embodiments, the mobile computing device 302 includes a mobile telephone, laptop, netbook, gaming device, and/or portable media player. The computing device 104 may also include less portable devices such as desktop personal computers, kiosks, and tabletop devices. Additionally, the computing device 104 may represent a group of processing units or other computing devices.

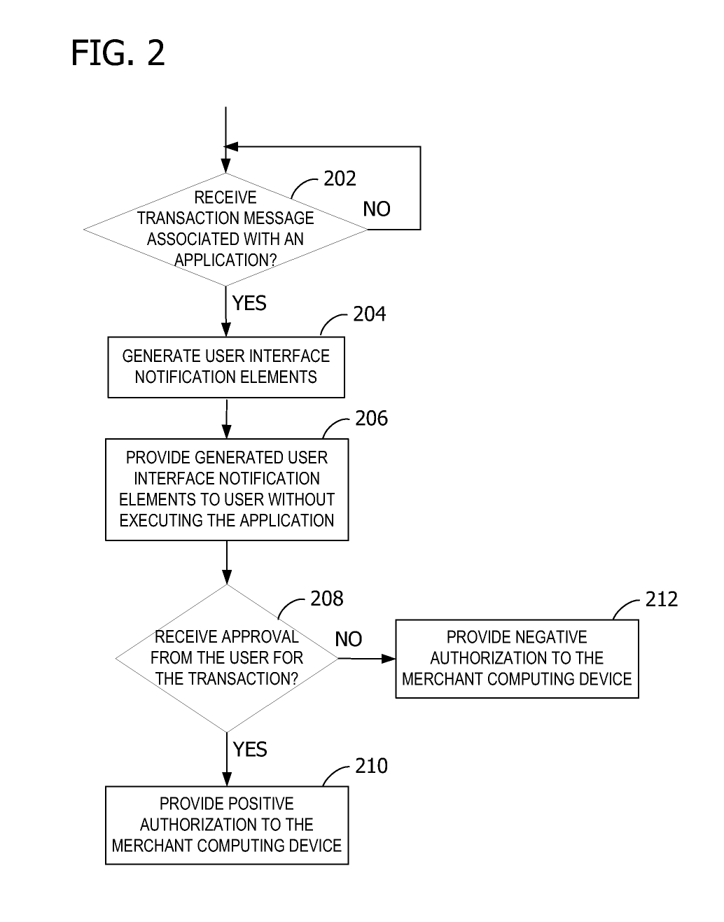

The computing device 104 has at least one processor 106 and a memory area 108. The processor 106 includes any quantity of processing units, and is programmed to execute computer-executable instructions for implementing aspects of the disclosure. The instructions may be performed by the processor 106 or by multiple processors executing within the computing device 104, or performed by a processor external to the computing device 104. In some embodiments, the processor 106 is programmed to execute instructions such as those illustrated in the figures (e.g., FIG. 2).

The computing device 104 further has one or more computer-readable media such as the memory area 108. The memory area 108 includes any quantity of media associated with or accessible to the computing device 104. The memory area 108 may be internal to the computing device 104 (as shown in FIG. 1), external to the computing device 104 (not shown), or both (not shown).

The memory area 108 stores, among other data, one or more applications 110 and at least one operating system 112. The applications 110, when executed by the processor 106, operate to perform functionality on the computing device 104. Exemplary applications 110 include mail application programs, web browsers, calendar application programs, and address book application programs. The applications 110 may communicate with counterpart applications or services such as web services accessible via a network. For example, the applications 110 may represent client-side applications that correspond to server-side services such as online banking, online auctions, network access management, and the like.

The operating system 112 represents any operating system designed to provide at least basic functionality to operate the computing device 104 along with a context or environment in which to execute the applications 110.

The memory area 108 further stores one or more computer-executable components. Exemplary components include a communications interface component 114, a graphics component 116, and a user interface component 118. The communications interface component 114, when executed by the processor 106 of the computing device 104 (e.g., a first computing device), causes the processor 106 to receive, by the first computing device from a second computing device, a transaction message identifying a transaction associated with at least one of the applications 110 available on the first computing device. The transaction message further specifies the user 102 of the first computing device. In some embodiments, the transaction is associated with one or more of the following: payment of an invoice, rejection of an invoice, acceptance of a network connection, rejection of a network connection, entry of an auction bid, purchase of a security, and sale of a security. For example, the transaction message includes one or more of the following: a bill pay notification, a network connection notification, a stock quote, and data relating to an auction transaction.

In some embodiments, the communications interface component 114 includes a network interface card and/or computer-executable instructions (e.g., a driver) for operating the network interface card.

The graphics component 116, when executed by the processor 106 of the first computing device, causes the processor 106 to generate a sequence of user interface notification elements corresponding to the transaction message received by the communications interface. The sequence of user interface notification elements may be animated, or include animations.

In some embodiments, the graphics component 116 includes a graphics card for rendering graphical data to the user 102 and/or computer-executable instructions (e.g., a driver) for operating the graphics card.

The communications interface component 114, when executed by the processor 106 of the first computing device, causes the processor 106 to display, or provide for display, the sequence of user interface notification elements generated by the graphics component 116 to convey to the user 102 the transaction message received by the communications interface. The user interface component 118 further executes to receive user input to one or more of the displayed user interface notification elements. The user input indicates an authorization relating to the transaction. The user input includes one or more of the following: a gesture, a movement of the first computing device, and a button press. The communications interface component 114 further executes to provide the authorization to the second computing device.

In some embodiments, the user interface component 118 includes a display (e.g., a touch screen display) and/or computer-executable instructions (e.g., a driver) for operating the display. The user interface component 118 may also include one or more of the following to provide data to the user 102 or receive data from the user 102: speakers, a sound card, a vibration motor, and one or more accelerometers.

The transaction message is provided for display to the user 102 separate from, or independent of, the application 110 associated with the transaction message. That is, the application 110 is not executed to enable the user 102 to view the transaction message and for the user 102 to provide the user input to the user interface notification element. In some embodiments, the communications interface component 114, graphics component 116, and user interface component 118 collectively represent a notification architecture or notification functionality that operates to provide the transaction message to the user 102 and receive the user input from the user 102 via the user interface notification elements. The notification architecture may also include a notification service 304 such as illustrated in FIG. 2. In other embodiments, one or more of the communications interface component 114, graphics component 116, and user interface component 118 are associated with the operating system 112.

Referring next to FIG. 2, an exemplary flow chart illustrates operation of the computing device 104 to provide transaction messages to the user 102 and receive authorization for the transactions. If a transaction message associated with one of the applications 110 is received by the computing device 104 from another computing device (e.g., a merchant computing device 306) at 202, the user interface notification elements are generated at 204. Alternatively or in addition, the user interface notification elements may be provided to the computing device 104 by, for example, the merchant computing device 306. At 206, the user interface notification elements are provided to the user 102 without executing the application 110.

The user 102 views the transaction message via the user interface notification elements and provides input via the user interface notification elements. The input includes authorization relating to the transaction. For example, if the computing device 104 receives approval from the user 102 for the transaction at 208, positive authorization is provided by the computing device 104 to the merchant computing device 306 at 210. If the computing device 104 does not receive approval (e.g., receives a rejection or denial), negative authorization is provided by the computing device 104 to the merchant computing device 306 at 212. The computing device 104 receives the positive or negative authorization without executing the application 110 associated with the transaction.

In some embodiments, a plurality of transaction messages is received. Each of the transaction messages is associated with one of the applications 110 available on the computing device 104. User interface notification elements are generated to convey the transaction messages. In some embodiments, the user interface notification elements are collectively displayed to the user 102 in a single user interface, window, popup, bubble, or the like. For example, the user interface notification elements may be organized or arranged for display on a home screen or a default screen of the computing device 104 (e.g., the mobile computing device 302) as a set of tiles, toasts, icons, or other user interface notification elements.

In a further embodiment, when the user interface notification elements(s) are displayed to the user 102, the user 102 may decide to execute the application 110 on the computing device 104 to, for example, obtain further information. The user 102 may click on one of the user interface notification elements, or a portion thereof, to launch the application 110. Responsive to receiving a request from the user 102 to execute the application 110, the computing device 104 launches the application 110. The user 102 may then interact with the application 110 to complete the transaction (e.g., provide positive or negative authorization for the transaction).

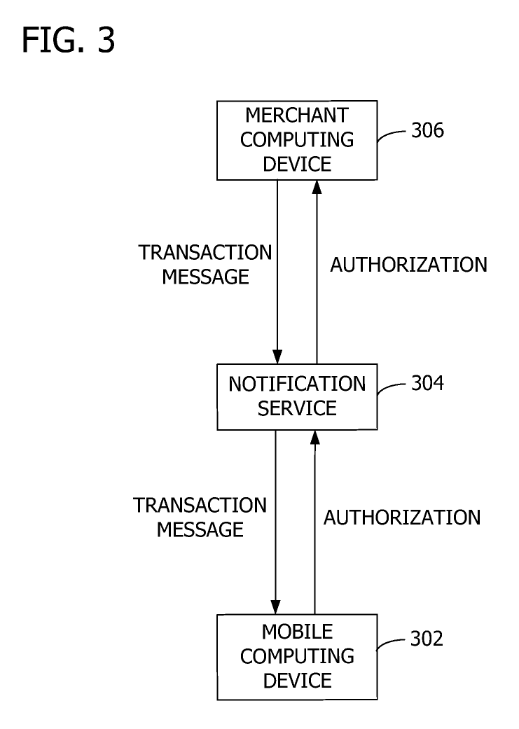

Some embodiments, as next described with reference to FIG. 3, contemplate the user 102 registering or subscribing with the notification service 304 to receive the transaction messages.

Referring next to FIG. 3, an exemplary block diagram illustrates communication between the mobile computing device 302, the notification service 304, and the merchant computing device 306 to enable positive or negative authorization of transactions by the user 102 via the user interface notification elements. The user 102 registers or subscribes to receive and/or enable receipt of notifications from the merchant computing device 306 via the notification service 304. For example, an operating system associated with the mobile computing device 302 receives a subscription request from the user 102. The mobile computing device 302 provides the received subscription request to the notification service 304. In some embodiments, the subscription request includes identification, authentication, and authorization information, or any other sign-in and/or security information associated with the user 102. For example, the user 102 may provide the notification service 304 with a login and password associated with an account of the user 102 maintained by the merchant computing device 306. In another example, the user 102 may further provide an account number, such as when the merchant computing device 306 is associated with online banking.

By providing the data associated with the user 102 and the merchant computing device 306 to the notification service 304, the mobile computing device 302 enables the operating system of the mobile computing device 302 to communicate with the merchant computing device 306 without executing the application 110 associated with the merchant computing device 306 on the mobile computing device 302.

The subscription request is conveyed to the merchant computing device 306. In some embodiments, the mobile computing device 302 also activates the subscription with a mobile operator enabling communication between the mobile computing device 302 and other devices.

The merchant computing device 306 provides a transaction message to the notification service 304. The notification service 304 provides the transaction message (e.g., as a notification) to the mobile computing device 302. The transaction message identifies a transaction associated with one of the applications 110 available on the mobile computing device 302. For example, the merchant computing device 306 provides a transaction message for consumption by one of the applications 110 on the mobile computing device 302 that is associated with the merchant computing device 306 (e.g., a client-side application that communicates with the merchant computing device 306). The transaction message is destined for the user 102 of the mobile computing device 302 and may specify the user 102 by including, for example, a user identifier associated with the user 102.

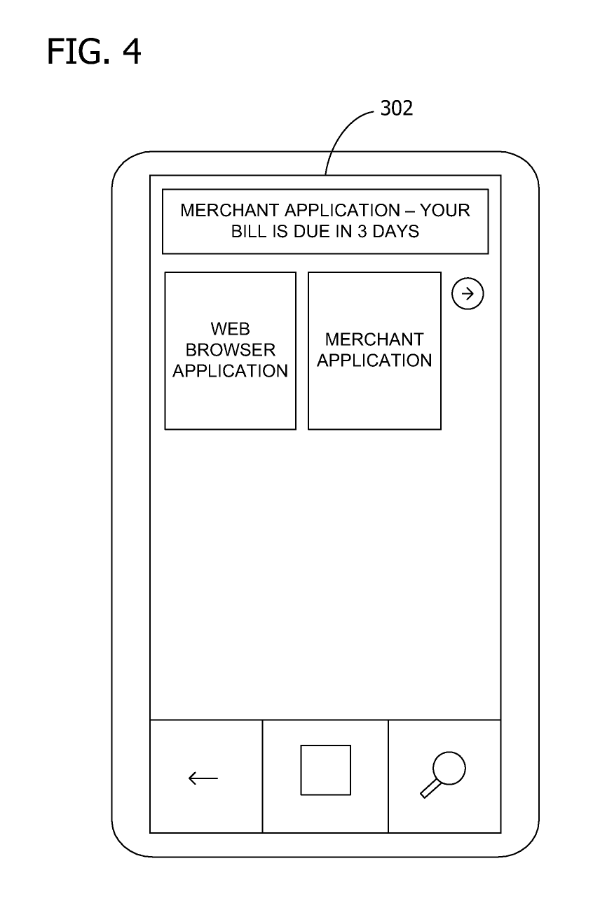

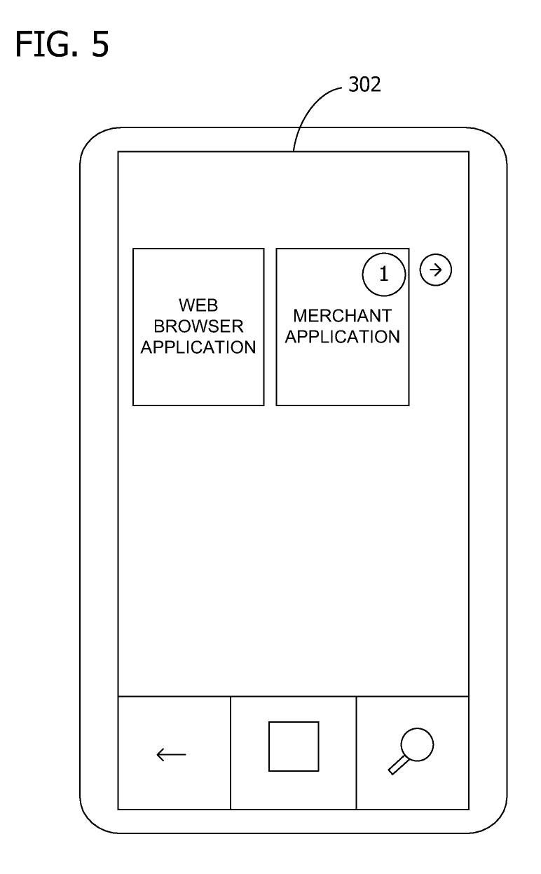

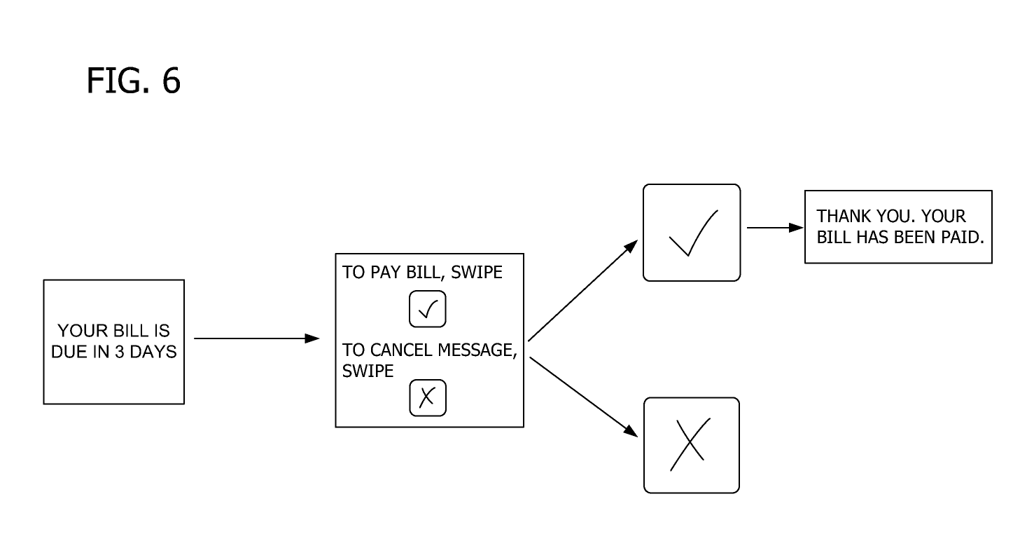

The mobile computing device 302 provides the received transaction message to the user 102 via one or more of the user interface notification elements associated with the operating system of the mobile computing device 302. Exemplary user interface notification elements are illustrated in FIG. 4, FIG. 5, and FIG. 6 below.

The user 102 of the mobile computing device 302 views and interacts with the user interface notification elements to provide positive or negative authorization for the transaction associated with the provided transaction message. The authorization received by the mobile computing device 302 from the user 102 is provided to the notification service 304, independent of and/or separate from the application 110. The notification service 304 passes the authorization to the merchant computing device 306.

Referring next to FIG. 4, an exemplary mobile computing device 302 illustrates display of a transaction message in a banner on a user interface. The banner is a representative user interface notification element, and is provided by the operating system of the mobile computing device 302). The user interface in FIG. 4 further displays two tiles also provided by the operating system: one which, when activated, executes a Web Browser Application and one which, when activated, executes a Merchant Application. Activation of the tiles includes clicking or selecting tiles to launch or otherwise execute the corresponding application 110. In general, each tile is associated with one of the applications 110 available on the mobile computing device 302.

At the top of the exemplary user interface, the banner displays messages to the user 102. Messages include, for example, application status messages, messaging notifications, network connection messages, and the like. While displayed at the top of the user interface, the banner may be displayed anywhere within the user interface (e.g., at the bottom, as a popup or bubble, etc.).

In the example of FIG. 4, the banner displays a message associated with the Merchant Application (e.g., “your bill is due in 3 days”). The user 102 is then able to interact with the banner, without executing the Merchant Application, to pay the bill (e.g., provide positive authorization for the transaction). For example, the user 102 is able to provide a gesture (e.g., a swipe at the banner), a click or double-click, or position a cursor on the banner in a pre-defined manner to provide the positive authorization.

Referring next to FIG. 5, an exemplary mobile computing device 302 illustrates display of a transaction message in one of the tiles on the user interface. The user interface displays the two tiles from FIG. 4. In contrast to the example illustrated in FIG. 4 in which the transaction messages are displayed to the user 102 in the banner, the transaction messages are displayed to the user 102 in FIG. 5 via the tiles. In the example of FIG. 5, a notification (e.g., a circled number one) appears in the Merchant Application tile. When the user 102 clicks or otherwise selects the notification, the transaction message is displayed within the Merchant Application tile.

While the notification in FIG. 5 is a circled number one, other notifications are within the scope of the disclosure. For example, the transaction message may appear within the tile on the home screen (e.g., at the top or bottom of the tile), or may replace any text currently within the tile. Other means for displaying the transaction message within the user interface notification elements are contemplated by aspects of the disclosure.

In some embodiments, a sequence of the transaction messages is illustrated in the tile. An exemplary sequence is next illustrated in FIG. 6.

Referring next to FIG. 6, an exemplary block diagram illustrates a sequence of user interface notification elements corresponding to a transaction. In the example of FIG. 6, the sequence of user interface notification elements includes a sequence of tiles displaying the transaction messages. For example, the transaction message “Your bill is due in 3 days” appears within the tile, followed by instructions on how to provide positive authorization or negative authorization for the transaction.

The user 102 provides the positive authorization or the negative authorization. For example, the user 102 swipes a pre-defined gesture within the tile, or in some embodiments, anywhere on the screen of the mobile computing device 302. The user may input, as an example, a check mark indicating the positive authorization, or may input, as an example, a letter X as the negative authorization. The positive authorization or negative authorization is provided to the merchant computing device 306 associated with the application 110 corresponding to the tile. Providing the authorization occurs without executing, on the mobile computing device 302, the application 110 associated with the tile. Instead, for example, the authorization is provided via the operating system associated with the mobile computing device 302.

The merchant computing device 306 may indicate acceptance of the positive authorization. A further transaction message indicating such acceptance is displayed in the example of FIG. 6 (e.g., displayed by the operating system, not by or during execution of the application 110 associated with the tile). Similarly, if a negative authorization is received by the mobile computing device 302 and provided to the merchant computing device 306, an acceptance of the dismissal of the transaction by the merchant computing device 306 may be displayed in the tile.

Some embodiments may show additional or less information than illustrated in FIG. 6. For example, the amount owed may also be displayed in the tile. Further, the tile, or a portion thereof, may be linked to a command that executes the application 110 associated with the tile. In this manner, the user 102 is able to click, select, or otherwise activate the link to execute the application 110 to obtain additional information relating to the transaction.

In general, aspects of the disclosure are operable with any computing device having functionality for providing data for display to the user 102 and receiving data input by the user 102. For example, the computing device 104 may provide content for display visually to the user 102 (e.g., via a screen such as a touch screen), audibly (e.g., via a speaker), and/or via touch (e.g., vibrations or other movement from the computing device 104). In another example, the computing device 104 may receive from the user 102 tactile input (e.g., via buttons, an alphanumeric keypad, or a screen such as a touch screen) and/or audio input (e.g., via a microphone). In further embodiments, the user 102 inputs commands or manipulates data by moving the computing device 104 itself in a particular way.

### Additional Examples

At least a portion of the functionality of the various elements in FIG. 1 and FIG. 3 may be performed by other elements in FIG. 1 or FIG. 3, or an entity (e.g., processor, web service, server, application program, computing device, etc.) not shown in FIG. 1 or FIG. 3.

In some embodiments, each of the operations illustrated in FIG. 2 are performed by the same computing device (e.g., computing device 104). In other embodiments, one or more of the operations illustrated in FIG. 2 are performed by another computing device (e.g., as a web service). Further, the operations illustrated in FIG. 2 may be implemented as software instructions encoded on a computer-readable medium, in hardware programmed or designed to perform the operations, or both.

While embodiments have been described with reference to data collected from users 102, aspects of the disclosure provide notice to the users 102 of the collection of the data (e.g., via a dialog box or preference setting) and the opportunity to give or deny consent. The consent may take the form of opt-in consent or opt-out consent.

### Exemplary Operating Environment

Exemplary computer readable media include flash memory drives, digital versatile discs (DVDs), compact discs (CDs), floppy disks, and tape cassettes. By way of example and not limitation, computer readable media comprise computer storage media and communication media. Computer storage media store information such as computer readable instructions, data structures, program modules or other data. Communication media typically embody computer readable instructions, data structures, program modules, or other data in a modulated data signal such as a carrier wave or other transport mechanism and include any information delivery media. Combinations of any of the above are also included within the scope of computer readable media.

Although described in connection with an exemplary computing system environment, embodiments of the invention are operational with numerous other general purpose or special purpose computing system environments or configurations. Examples of well known computing systems, environments, and/or configurations that may be suitable for use with aspects of the invention include, but are not limited to, mobile computing devices, personal computers, server computers, hand-held or laptop devices, multiprocessor systems, gaming consoles, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

Aspects of the invention transform a general-purpose computer into a special-purpose computing device when configured to execute the instructions described herein.

The embodiments illustrated and described herein as well as embodiments not specifically described herein but within the scope of aspects of the invention constitute exemplary means for providing the transaction message to the user 102 without executing the application 110 associated with the transaction message, and exemplary means for exchanging data with the user 102 via the user interface notification element to complete the transaction.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A system comprising:
a memory area associated with a mobile computing device of a user, said memory area storing an operating system and one or more applications; and
a processor programmed to:
receive a subscription request from the user;
provide the received subscription request to a notification service in communication with a merchant computing device;
receive, by the mobile computing device from the merchant computing device based on the subscription request, a transaction message identifying a transaction associated with one of the applications stored in the memory area, said transaction message further specifying the user of the mobile computing device;
provide the received transaction message to the user via a user interface notification element associated with the operating system;
receive user input to the user interface notification element, said user input indicating an authorization relating to the transaction; and
provide the authorization to the merchant computing device.

2. The system of claim 1, wherein the processor is programmed to provide the received transaction message to the user via the user interface notification element separate from said one of the applications.

3. The system of claim 1, wherein the transaction message comprises one or more of the following: a bill pay notification, a network connection notification, a stock quote, and data relating to an auction transaction.

4. The system of claim 1, wherein the user interface notification element comprises one or more of the following: a tile, a toast, a popup, and a bubble.

5. The system of claim 1, wherein the processor is further programmed to:
receive, from the user, a request to execute said one of the applications; and
responsive to the received request, execute said one of the applications.

6. The system of claim 1, further comprising means for providing the transaction message to the user without executing said one of the applications, and means for exchanging data with the user via the user interface notification element to complete the transaction.

7. The system of claim 1, wherein the user input comprises one or more of the following: a check mark indicating a positive authorization, and a letter X indicating a negative authorization.

8. A method comprising:
receiving, by a first computing device from a second computing device, a transaction message identifying a transaction associated with an application available on the first computing device, said transaction message further specifying a user of the first computing device;
providing the received transaction message to the user via a user interface notification element associated with an operating system executing on the first computing device;
receiving user input to the user interface notification element, said user input indicating an authorization relating to the transaction; and
providing the authorization to the second computing device.

9. The method of claim 8, wherein receiving the user input comprises receiving user input indicating a positive authorization or a negative authorization.

10. The method of claim 8, wherein providing the received transaction message to the user comprises providing the received transaction message to the user via a plurality of user interface notification elements.

11. The method of claim 8, wherein an operating system associated with the first computing device has notification functionality associated therewith, said notification functionality being separate from the application, and wherein providing the received transaction message comprises providing the received transaction message via the notification functionality.

12. The method of claim 8, wherein providing the received transaction message and receiving the user input occurs without executing the application.

13. The method of claim 8, wherein receiving the transaction message comprises receiving a plurality of transaction messages each associated with one of a plurality of applications available on the first computing device.

14. The method of claim 13, wherein providing the received plurality of transaction messages comprises providing the received plurality of transaction messages to the user via a plurality of user interface notification elements arranged for display in a single user interface of the first computing device.

15. The method of claim 13, wherein the first computing device comprises a mobile computing device, and wherein providing the received plurality of transaction messages comprises providing the received plurality of transaction messages to the user via a plurality of user interface notification elements arranged for display on a home screen of the mobile computing device.

16. The method of claim 8, further comprising:
receiving a request from the user via the user interface notification element to execute the application; and
responsive to the received request, executing the application.

17. One or more computer-readable media having computer-executable components, said components comprising:
a communications interface component that when executed by at least one processor of a first computing device of a user causes the at least one processor to receive, by the first computing device from a second computing device, a transaction message identifying a transaction associated with an application available on the first computing device, said transaction message further specifying the user of the first computing device;
a graphics component that when executed by at least one processor of the first computing device causes the at least one processor to generate a sequence of user interface notification elements corresponding to the transaction message received by the communications interface; and
a user interface component that when executed by at least one processor of the first computing device causes the at least one processor to display, without execution of the application by the at least one processor, the sequence of user interface notification elements generated by the graphics component to convey to the user the transaction message received by the communications interface, said user interface component further executing to receive user input to one or more of the displayed user interface notification elements, said user input indicating an authorization relating to the transaction;
wherein the communications interface component further executes to provide the authorization to the second computing device.

18. The computer-readable media of claim 17, wherein the transaction is associated with one or more of the following: payment of an invoice, rejection of an invoice, acceptance of a network connection, rejection of a network connection, entry of an auction bid, purchase of a security, and sale of a security.

19. The computer-readable media of claim 17, wherein the user interface component is associated with an operating system.

20. The computer-readable media of claim 17, wherein the user input comprises one or more of the following: a gesture, a movement of the first computing device, and a button press.
